(19) United States
(12) Patent Application Publication
(10) Pub. No.: US 2024/0413710 A1
(43) Pub. Date: Dec. 12, 2024

(54) ELECTRIC MACHINE WITH A STATOR COOLING ASSEMBLY

(71) Applicant: Dana Automotive Systems Group, LLC, Maumee, OH (US)

(72) Inventors: Eric M. ENGERMAN, Plymouth, MI (US); Ryan D. NELMS, Weatherford, TX (US); Gopinathan THIRUNAVUKKARASU, Canton, MI (US)

(21) Appl. No.: 18/678,442

(22) Filed: May 30, 2024

Related U.S. Application Data
(60) Provisional application No. 63/507,340, filed on Jun. 9, 2023.

(51) Int. Cl. H02K 9/193; H02K 1/20; H02K 5/20

(52) U.S. Cl. CPC H02K 9/193; H02K 1/20; H02K 5/203

(57) ABSTRACT

Methods and systems for an electric machine. The electric machine includes, in one example, a sleeve that encloses a stator and a rotor, a housing removably coupled to the sleeve and circumferentially enclosing a portion of the sleeve. The electric machine further includes a fluid inlet that extends through at least one of the sleeve and the housing and is in fluidic communication with a stator cooling assembly.

### CROSS-REFERENCE TO RELATED APPLICATION

The present application claims priority to U.S. Provisional Application No. 63/507,340, entitled “ELECTRIC MACHINE WITH A STATOR COOLING ASSEMBLY”, and filed on Jun. 9, 2023. The entire contents of the above-listed application are hereby incorporated by reference for all purposes.

### TECHNICAL FIELD

The present disclosure relates to an electric machine with a sleeve coupled to a stator and a cooling assembly for the stator.

### BACKGROUND AND SUMMARY

In electric motors, such as electric motors in electric vehicle (EV) applications, thermal management can affect motor sizing, efficiency, and performance. Certain motor designs have attempted to use immersion cooling to increase motor efficiency and downsize the machine in certain cases. However, the inventors have recognized that it can be difficult to seal the stator in a manner that is simple to manufacture. This difficultly is compounded when motor serviceability is demanded. Consequently, immersion cooling the stator may lead to fluid leakage and present obstacles to efficient manufacture of the motor, thereby decreasing customer appeal.

To overcome at least some of the abovementioned issues the inventors developed an electric machine. The electric machine includes, in one example, a sleeve that encloses a stator and a rotor. The electric machine further includes a housing which is removably coupled to the sleeve and circumferentially encloses a portion of the sleeve. The electric machine further includes a fluid inlet that extends through the sleeve and the housing and is in fluidic communication with an end winding chamber in a stator cooling assembly. The sleeve and housing construction allows the stator cooling assembly to implement immersion cooling with a decreased chance of fluid leakage in a package that is more efficient to manufacture and service.

Further, in one example, the stator cooling assembly includes the first end winding chamber that is positioned on a first axial side of the electric machine and in direct fluidic communication with the fluid inlet. In such an example, the stator cooling assembly further includes a second end winding chamber positioned on a second axial side of the electric machine. Continuing with the example, the stator cooling assembly further includes a cooling channel that axially extends through a stator core. In this way, the stator is able to be effectively immersion cooled, thereby increasing electric machine efficiency.

Still further, in one example, the electric machine may include an end winding sealing component forming at least a portion of a boundary of the first end winding chamber. In such an example, the end winding sealing component may be coupled (e.g., welded, flow formed, and the like) with the sleeve. In this way, the stator end windings may be effectively sealed to reduce the chance of fluid leakage.

It should be understood that the summary above is provided to introduce in a simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a cross-sectional view of an example of an electric machine with a stator cooling assembly.

FIG. 2 shows a detailed view of the electric machine, depicted in FIG. 1.

FIG. 3 shows a first example of an electric machine with a stator cooling assembly.

FIG. 4 shows a second example of an electric machine with a stator cooling assembly.

FIG. 5 shows a third example of an electric machine with a stator cooling assembly.

FIG. 6 shows a fourth example of an electric machine with a stator cooling assembly.

FIG. 7 shows a fifth example of an electric machine with a stator cooling assembly.

FIG. 8 shows an example of an electric machine housing for a stator cooling assembly.

### DETAILED DESCRIPTION

An electric machine is described herein that includes a stator cooling assembly which effectively cools the machine's stator to a greater extent than previous motor cooling systems in a package that is easy to manufacture and service and has a reduced chance of fluid leakage. To achieve the stator cooling, the electric machine includes a sleeve and housing assembly where the sleeve is press-fit or otherwise coupled to a stator. The sleeve may include a flange that allows one or more housing sections to be attached thereto. A fluid inlet is formed in the housing and/or the sleeve which allows oil, or other suitable working fluid, to be directed to stator end windings and then to channels that axially extend through the stator. In this way, the stator is efficiently cooled using an assembly that is able to be efficiently manufactured and serviced. Consequently, customer appeal of the electric machine is increased.

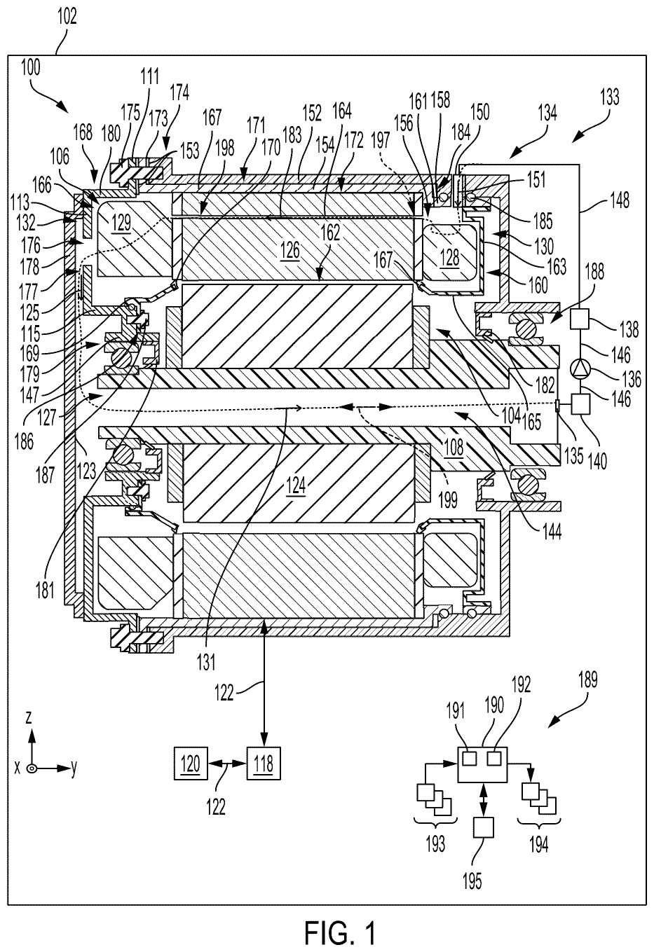

FIG. 1 shows an illustration of an electric machine 100. The electric machine 100 may be designed as an electric motor-generator and may be included in a system 102 which may take a variety forms. For instance, the electric machine 100 may be incorporated into an electric drive of an electric vehicle (EV). In such an example, the electric machine 100 may be a traction motor. The other electric machines described herein may be traction motors. In the EV example, the EV may be an all-electric vehicle (e.g., a battery electric vehicle (BEV)), in one example, or a hybrid electric vehicle (HEV), in another example. For instance, the electric machine may be mechanically coupled to a transmission (e.g., gearbox) that is coupled to drive wheels using one or more differentials, for example. Further, in the EV example, the electric machine may be a traction motor that delivers mechanical power to drive wheels. In the HEV example, the electric machine may be included in an electric axle, and an internal combustion engine may provide motive power to another drive axle. However, the motor may be used in other suitable systems (e.g., stationary systems), in other examples, such as in industrial machines, agricultural systems, mining systems, and the like.

The electric machine 100 includes a rotor 104 that electromagnetically interacts with a stator 106 to drive rotation of a rotor shaft 108 that is included in the rotor. The stator 106 at least partially surrounds the rotor 104. As such, the electric machine 100 may be a radial flux style motor.

The electric machine 100 in the illustrated example includes a housing 152. The housing may include an electrical interface. The electrical interface may be a multi-phase electrical interface with multiple electrical connectors. The electrical interface may be a three-phase interface, in one example, or a six or nine phase interface, in other examples. More generally, the electric machine 100 may be a multi-phase alternating current (AC) machine. However, in other examples, the electric machine 100 may be a direct current (DC) motor.

As illustrated in FIG. 1, the electric machine 100 may be electrically coupled to an inverter 118. The inverter 118 is designed to convert DC power to AC power and vice versa. As such, the electric machine 100 may be an AC electric machine, as indicated above. However, in other examples, the electric machine 100 may be a DC electric machine (as previously indicated), and the inverter 118 may therefore be omitted from the system 102. The inverter 118 may receive electric energy from one or more energy storage device(s) 120 (e.g., one or more traction batteries, capacitors, fuel cells, combinations thereof, and the like). Arrows 122 signify the electric energy transfer between the electric machine 100, the inverter 118, and the energy storage device(s) 120 that may occur during different modes of system operation.

The rotor 104 may include a core 124 that has a stack of laminations. In the stack, laminations, that may be formed of a metal, are sequentially arranged and coupled (e.g., bonded and/or welded) to one another.

Continuing with FIG. 1, the stator 106 may include a core 126 through which windings extend. These windings protrude from the stator core on either axial end to form the end windings 128, 129. The end windings 128, 129 may be positioned on opposing axial sides 130, 132, respectively, of the electric machine.

The stator core 126 may include a stack of laminations. It will be understood that the stack of stator laminations may have openings through which the windings extends. The stator lamination stack includes multiple metal sheets that are sequentially arranged and may be stacked, welded, and/or bonded together, in different instances.

The end windings 128, 129 generate heat during machine use. As such, cooling of the end windings to increase motor efficiency may be desired. A cooling system 133 (e.g., an immersion cooling system) that includes a stator cooling assembly 134 is provided in the electric machine to remove heat from the end windings 128, 129 and the stator core 126. The stator cooling assembly 134 may specifically be an immersion type cooling assembly that is configured to circulate a working fluid (e.g., oil) through various sections of the stator to remove heat therefrom and increase machine operation efficiency.

The stator cooling assembly 134 in the illustrated example, includes a fluid pump 136 and a heat exchanger 138. The pump 136 may include a pick-up in a sump 140 that may include a filter. As such, the stator cooling assembly 134 may be pressurized (e.g., pressurized at a pressure above atmospheric pressure) during operation. The sump 140 may be positioned in an internal enclosure of the electric machine 100 and is contoured to collect the working fluid from a rotor shaft conduit 144. The working fluid used in the stator cooling assembly 134 may specifically be oil (e.g., natural and/or synthetic oil), in one example. However, other suitable types of coolant have been contemplated. The pump 136 and heat exchanger 138 are incorporated into the electric machine 100 in the illustrated example. However, in other examples, the pump, the sump, and/or the filter may be spaced away from the machine's housing or externally coupled thereto. The location of the pump, the sump, and the filter may be selected based on the machine's end-use packaging constraints, for instance.

The stator cooling assembly 134 may include fluid conduits 146 that fluidly connect the heat exchanger 138, the pump 136, and the sump 140 and a fluid conduit 148. The fluid conduit 148 fluidly connects the heat exchanger 138 to a fluid inlet 150 which extends through a housing 152 and a sleeve 154, in the illustrated example. However, in other examples, the fluid inlet 150 may extend solely through the housing. Arrow 151 indicates the general direction of coolant flow through the inlet 150. Therefore, the coolant travels from the pump 136, through the fluid conduit 148, and to the inlet 150.

The fluid inlet 150 is in direct fluidic communication with an end winding chamber 156. As such, coolant flows from the fluid inlet 150 and into the end winding chamber 156. A boundary of the end winding chamber 156 may be formed by a portion 158 of the sleeve 154 and an end winding sealing component 160. To elaborate, an outer circumferential wall 161 of the chamber may be formed by a portion of the sleeve 154. The end winding chamber 156 may include an end wall 163 and an inner circumferential wall 165 may be formed via end winding sealing component. A seal 167 in the end winding sealing component 160 may be in sealing contact with the stator 106 at one end, thereby sealing the chamber 156 from an air gap 162. An end of the end winding sealing component 160 may be coupled to an inner periphery of the sleeve 154. The end winding chamber 156 allows the end winding 128 to be immersively cooled.

One or more cooling channels 164 may axially extend through the stator core 126. The one or more cooling channels 164 are in fluidic communication with the end winding chamber 156 and another end winding chamber 166. A boundary of the end winding chamber 166 may be formed by a portion of the sleeve 154, a housing section 168, and an end winding scaling component 169. The cooling system may further include a seal 170 that is in sealing contact with the stator 106 and seals the chamber 166 from an air gap 162. The boundary of the end winding chamber 166 may be formed via an outer circumferential wall 180, an end wall 113, and an inner circumferential wall 115 which are included in the housing section 168. The end winding sealing component 169 may also form the boundary of the end winding chamber 166. To elaborate, the end winding scaling component 169 may be coupled to the end winding sealing component 169 via flanges 186 and one or more attachment device(s) 187 (e.g., bolts, screws, combinations thereof, and the like). The flanges 186 may be coupled to a bearing 179. To elaborate, a section 147 of one of the flanges is in face sharing contact with the bearing 179 and specifically an outer race of the bearing. The bearing 179 and the other bearings described herein include an outer race, roller elements (e.g., spherical balls, cylindrical rollers, tapered cylindrical rollers, and the like), and an inner race.

An interface 171 is formed between the housing 152 and the sleeve 154. Further, an interface 172 is formed between the stator 106 and the sleeve 154. The interface 171 may be a pilot fit interface. In this way, the housing and the sleeve may be efficiently assembled and disassembled. Further, the interface 172 may be a press fit interface. Consequently, the chance of fluid leakage from the interface is reduced. The inner diameters and the outer diameters of the sections that form the interface may be substantially constant along their lengths aside from the stepped portion, discussed in greater detail herein, to allow the components to be effectively mated to form the interfaces. However, other interface contours are possible.

The sleeve 154 may further include a flange 173. The housing 152 and specifically the housing section 168 and a housing section 174 (e.g., a housing body) may be removably coupled to the flange 173 via attachment device(s) 175. Seals 153 may be positioned between the flange 173 and the housing sections that are adjacent thereto. The seals 153 may be gaskets that may be formed from room-temperature-vulcanizing silicone (RTV), in one specific example.

The housing section 168 may be removably attached to the flange 173. The housing section 168 at least partially encloses the end winding 129. Further, the housing section may include an opening 176 that allows the fluid to be directed from the end winding chamber 166 to a fluid passage 177 that extend between the opening 176 and the rotor shaft conduit 144. An inner surface of an end plate 178 may form a portion of the boundary of the fluid passage 177. The end plate 178 may be removably coupled to the housing section 168. The boundary of the fluid passage 177 is formed by an interior wall 123 of the end plate 178. Arrow 125 indicates the general direction of coolant flow through the fluid passage 177. The fluid passage 177 is in direct fluidic communication with an inlet 127 of the rotor shaft conduit 144, in the illustrated example. Arrow 131 indicates the general direction of coolant flow through the rotor shaft conduit 144. An outlet 135 of the rotor shaft conduit 144 is in fluidic communication with the sump 140.

The bearing 179 may be coupled to the rotor shaft 108 to permit rotation thereof and support the shaft. Another bearing 188 is coupled to the rotor shaft 108. The housing section 168 may be coupled to one of the bearings 179. A rotor seal 181 may be coupled to the housing section 168 to reduce the chance of fluid leakage into the rotor and specifically the air gap which may reduce the machine's efficiency. The rotor seal 181 is positioned inboard from the bearing 179. A seal 182 is coupled to the housing section 174 and the bearing 179 and reduces the likelihood of fluid leaking into the rotor. The seals 181 and 182 may be rotary seals, such as labyrinth seals, in one specific example.

The housing section 174 includes a flange attachment extension 111 that allows the housing to be effectively attached to the flange 173. A seal may be used at the interface between the housing section and the flange to reduce coolant leakage from the cooling system.

Arrow 183 indicates the general direction of fluid flow through the stator core 126. To expound, the one or more cooling channels 164 each include an inlet 197 and an outlet 198. The inlet 197 opens into the end winding chamber 156 and the outlet 198 opens into the end winding chamber 166. The arrows which indicate the direction of coolant flow denote the general direction of coolant flow in the cooling system. However, it will be understood that the fluid flow pattern in the cooling assembly has greater complexity, in practice.

In the illustrated example, the sleeve 154 includes a step 184 which enables the sleeve to be effectively attached to the housing 152. However, other housing contours may be used in other examples, which are expanded upon herein. A seal 185 is positioned between the housing 152 and the sleeve 154 at a location adjacent to the fluid inlet 150.

The system 102 may additionally include a control sub-system 189 with a controller 190. The controller 190 includes a processor 191 and memory 192. The memory 192 may hold instructions stored therein that when executed by the processor 191 cause the controller 190 to perform the various methods, control techniques, and the like, described herein. The processor 191 may include a microprocessor unit and/or other types of circuits. The memory 192 may include known data storage mediums such as random access memory, read-only memory, keep alive memory, combinations thereof, and the like.

The controller 190 may receive various signals from sensors 193 positioned in different locations in the system 102. The sensors 193 may include an electric machine speed sensor, energy storage device temperature sensor(s), an energy storage device state of charge sensor(s), an inverter power sensor, and the like. The controller 190 may also send control signals to various actuators 194 coupled at different locations in the system 102. For instance, the controller may send signals to the inverter 118 to adjust the rotational speed of the electric machine 100. In another example, the controller 190 may send a command signal to the electric machine 100 and/or the inverter 118 and in response motor speed may be adjusted. The other controllable components in the system 102 may function in a similar manner with regard to command signals and actuator adjustment.

The system 102 may also include one or more input device(s) 195 (e.g., an accelerator pedal, a brake pedal, a console instrument panel, a touch interface, a touch panel, a keyboard, combinations thereof, and the like). The input device(s) 195, responsive to user input, may generate a motor speed adjustment request, as well as other signals indicative of the operator's intent for system operation.

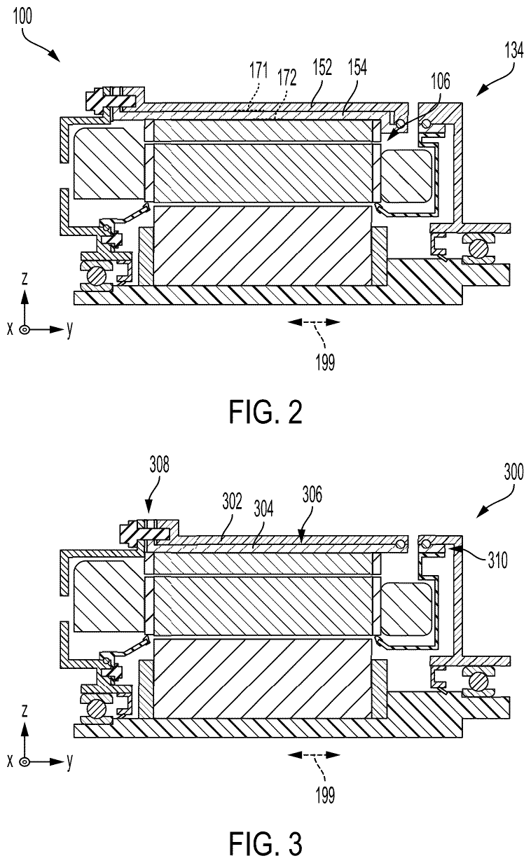

An axis system is provided in FIG. 1, as well as FIGS. 2-8, for reference. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. Rotational axes 199 of the electric machine 100 is further provided for reference in FIG. 1 as well as FIGS. 2-8. Cutting planes for the cross-sectional views shown in FIGS. 1-8 extend through the rotational axes 199.

FIG. 2 shows a detailed view of the electric machine 100 with the stator cooling assembly 134. The interface 171 between the housing 152 and the sleeve 154 and the interface 172 between the sleeve 154 and the stator 106 are again illustrated. As previously discussed, the interface 171 may be a pilot fit interface and the interface 172 may be a press fit interface.

FIG. 3 shows an electric machine 300. The electric machine 300 shown in FIG. 3 as well as the other machines described herein may have at least a portion of the structural and/or functional features of the electric machine 100 shown in FIG. 1 and vice versa. Redundant description of overlapping features of the electric machines is omitted for brevity.

The electric machine 300 includes a housing 302 and a sleeve 304. However, the step has been omitted from the sleeve 304 in the example shown in FIG. 3. As such, an interface 306 between the sleeve 304 and the housing 302 may have a substantially constant diameter along its length from a sleeve flange 308 to an axial end 310. It will be understood that the housing and sleeve configuration shown in FIG. 3 may be easier to manufacturing and assemble when compared to a housing and sleeve constructed with a step.

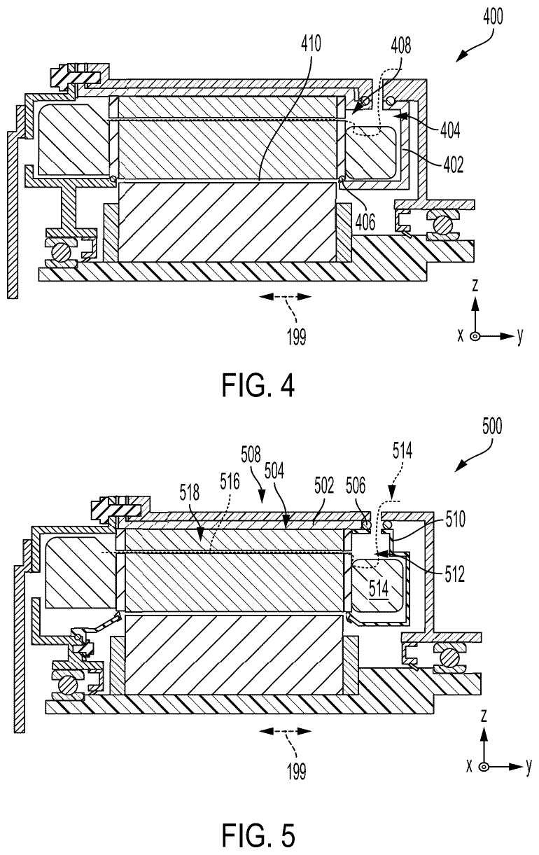

FIG. 4 shows an electric machine 400 with a sleeve section 402 that forms a boundary of the end winding chamber 404. Thus, the sleeve section 402 functions as an end winding scaling component. A seal 406 may be positioned between the sleeve section 402 and a stator 408 to reduce the chance of fluid leaking into the air gap 410.

FIG. 5 shows an electric machine 500 where a section 502 of a sleeve 504 has been axially shortened (compared to the previous embodiments) such that a seal 506 is positioned between a housing 508 and an end winding sealing component 510 that forms at least a portion of a boundary of an end winding chamber 512. It will be appreciated that the working fluid in a stator cooling assembly 514 may be circulated through the end winding chamber 512 and into a stator cooling channel 516 which axial extends through a stator 518.

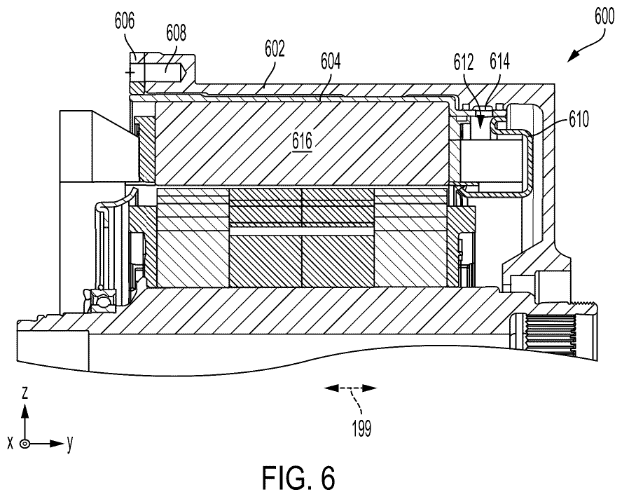

FIG. 6 shows an electric machine 600 with a housing 602 that mates with a sleeve 604 that includes a flange 606 through which an attachment device 608 may extend to removably attach the housing and the sleeve. An end winding sealing component 610 forms a portion of a boundary of an end winding chamber 612 that is in direct fluidic communication with a fluid inlet 614 and a coolant channel that axially extends through a stator 616. The end winding scaling component 610 interfaces with the sleeve 604, in the illustrated example.

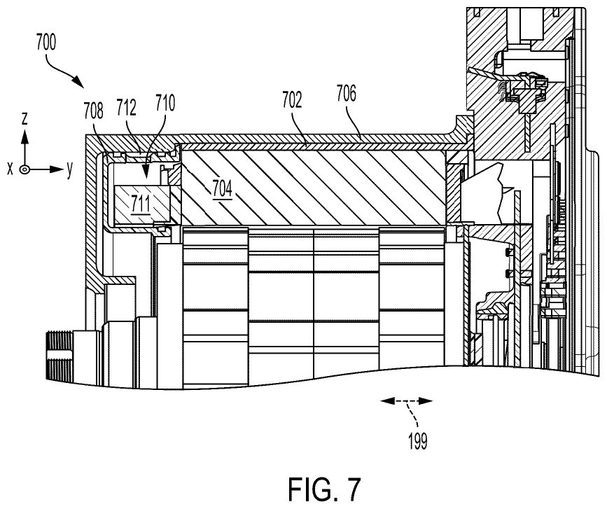

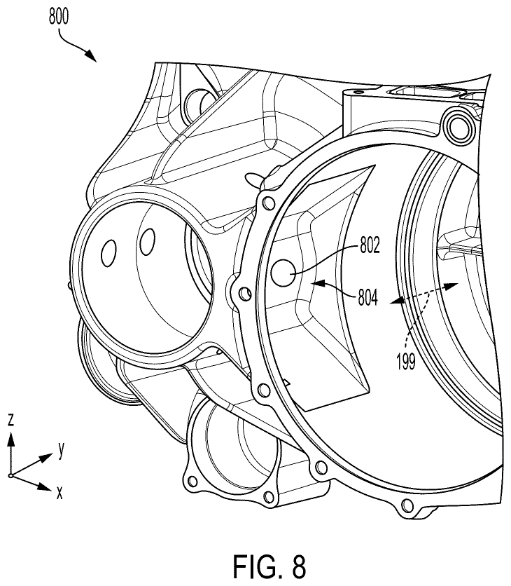

FIG. 7 shows another example of an electric machine 700 with a sleeve 702 that mates with a stator 704 and a housing 706 that mates with the sleeve. An end winding sealing component 708 forms a portion of a boundary of an end winding chamber 710 for an end winding 711 that is in direct fluidic communication with a fluid inlet 712.

FIG. 8 shows a housing 800 with a puddle weld 802 on an interior section 804 that may be welded prior to insertion of the motor and sleeve assembly. In this way, manufacturing may be further simplified and the likelihood of undesirable fluid leakage in the immersion cooling system may be further reduced.

The electric machines described above allows the electric machine to be efficiently manufactured and serviced in a package friendly manner and use robust and long lasting components. Customer appeal may be increased as a result.

FIGS. 1-8 provide for the following method for operation of an electric machine. The method may be implemented by any of the electric machines describe above or combinations of the electric machines. However, in other examples, the method may be implemented by other suitable electric machines. The method includes directing a working fluid from a pump to an inlet of a stator cooling assembly while the electric machine is operating. The method may further include directing fluid from the fluid inlet to a first end winding chamber, from the first end winding chamber to one or more axial cooling passages in the stator core, from the axial cooling passages to a second end winding chamber, from the second end winding chamber to a rotor shaft fluid conduit, and from the rotor shaft fluid conduit to a sump. In this way, coolant may be effectively directed through the machine to increase machine efficiency in a cooling assembly which is less likely to leak than previous immersion cooling systems.

FIGS. 1-8 may additionally provide for an electric machine manufacturing method. The manufacturing method includes, in one example, fitting (e.g., press fitting) the sleeve to the stator. The method may further include attaching end winding sealing components to the sleeve and/or a housing section. Still further the method may include mating (e.g., pilot fitting) the sleeve and stator assembly with a housing. Next the rotor assembly may be installed in the electric machine. The method may further comprise installing a back cover (which may include one or more pieces) with an integrated seal. The integrated seal may make contact with an inner diameter of a face of the stator and sandwiches the flange of the sleeve between a main housing and the back cover which may then be fastened together and sealed.

The technical effect of the method for electric machine operation is to increase machine efficiency by transferring greater amount of heat away from the end windings, when compared to other machine designs, and reduce the likelihood of fluid leakage from the stator cooling assembly.

FIGS. 7-8 are drawn approximately to scale. Although other relative component dimensions may be used, in other embodiments.

FIGS. 1-8 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, an electric machine is provided that comprises a sleeve enclosing a stator and a rotor; a housing removably coupled to the sleeve and circumferentially enclosing a portion of the sleeve; and a fluid inlet extending through at least one of the sleeve and the housing and is in fluidic communication with a first end winding chamber that surrounds a stator end winding; wherein the first end winding chamber is included in a stator cooling assembly. Further, in one example, the sleeve may include a section that extends partially around an end winding. Still further, in one example, the stator cooling assembly may include a first end winding chamber positioned on a first axial side of the electric machine and in direct fluidic communication with the fluid inlet; a second end winding chamber positioned on a second axial side of the electric machine; a cooling channel axially extending through a stator core. Still further in one example, the machine may additional include a rotor shaft conduit in fluidic communication with the second end winding chamber and a pump. The machine may further comprise, in one example, a first end winding sealing component forming at least a portion of a boundary of the first end winding chamber. The machine may further comprise, in one example, a second end winding sealing component forming at least a portion of a boundary of the second end winding chamber. Further in one example, the first end winding sealing component may be coupled with the sleeve. Further in one example, the housing may be pilot fit to the sleeve. The machine may further comprise, in one example, a seal positioned in an interface between the housing and the sleeve adjacent to the fluid inlet. Further in one example, the working fluid in the stator cooling assembly may be oil. Further in one example, the electric machine may be a multi-phase electric machine.

In another aspect, a method for operation of an electric machine is provided that comprises flowing a working fluid into a fluid inlet that extends through a sleeve and a housing and is in fluidic communication with a stator cooling assembly; wherein the electric machine includes: the housing enclosing a stator and a rotor; the sleeve removably coupled to the housing and circumferentially enclosing a portion of the housing; and the fluid inlet extending through the sleeve and the housing. The method may further comprise, in one example, flowing the working fluid from the fluid inlet to: a first end winding chamber that is positioned on a first axial side of the electric machine; wherein the stator cooling assembly further includes: a second end winding chamber positioned on a second axial side of the electric machine; a cooling channel axially extending through a stator core. The method may further comprise, in one example, flowing the working fluid from the second end winding chamber to a fluid channel that axially extends through a rotor shaft.

In yet another example, a traction motor is provided that comprises a sleeve enclosing a stator and a rotor; a housing removably coupled to the sleeve and circumferentially enclosing a portion of the sleeve; and a fluid inlet extending through the sleeve and the housing and is in fluidic communication with a stator cooling assembly; wherein the sleeve includes a flange and the housing is coupled to the flange via an attachment device. Further in one example, the housing may form a pilot fit interface with the sleeve. Further in one example, a diameter of the pilot fit interface may be substantially constant along an axial length from a flange to an axial end. Further in one example, the stator cooling assembly may be pressurized and includes: a first end winding chamber positioned on a first axial side of the electric machine and in direct fluidic communication with the fluid inlet; a second end winding chamber positioned on a second axial side of the electric machine; a cooling channel axially extending through a stator core. Further in one example, the first end winding chamber may include a seal that is adjacent to an inner diameter of the stator. The motor may further comprise, in one example, a back cover that forms a portion of a boundary of a conduit that directs fluid from the second end winding chamber to a rotor shaft conduit.

As used herein, the term “approximately” is construed to mean plus or minus five percent of the range, unless otherwise specified.

Note that the example control and estimation routines included herein can be used with various motor configurations. The control methods and routines disclosed herein may be stored as executable instructions in non-transitory memory and may be carried out by the control system including the controller in combination with the various sensors, actuators, and other system hardware in combination with the electronic controller. As such, the described actions, operations, and/or functions may graphically represent code to be programmed into non-transitory memory of the computer readable storage medium in the system. One or more of the illustrated actions, operations and/or functions may be repeatedly performed depending on the particular strategy being used. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine cooling system, comprising:
a sleeve enclosing a stator and a rotor;
a housing removably coupled to the sleeve and circumferentially enclosing a portion of the sleeve; and
a fluid inlet extending through at least one of the sleeve and the housing and is in fluidic communication with a first end winding chamber that surrounds a stator end winding;
wherein the first end winding chamber is included in a stator cooling assembly.

2. The electric machine cooling system of claim 1, wherein the sleeve includes a section that forms a boundary of the first end winding chamber.

3. The electric machine cooling system of claim 1, wherein the stator cooling assembly includes:
a second end winding chamber positioned on a second axial side of the electric machine; and
a cooling channel axially extending through a stator core and in fluidic communication with the first end winding chamber and the second end winding chamber.

4. The electric machine cooling system of claim 3, further comprising a rotor shaft conduit in fluidic communication with the second end winding chamber and a pump.

5. The electric machine cooling system of claim 3, further comprising a first end winding sealing component forming at least a portion of a boundary of the first end winding chamber.

6. The electric machine cooling system of claim 5, further comprising a second end winding sealing component forming at least a portion of a boundary of the second end winding chamber.

7. The electric machine cooling system of claim 5, wherein the first end winding sealing component is coupled with the sleeve.

8. The electric machine cooling system of claim 1, wherein the housing is pilot fit to the sleeve.

9. The electric machine cooling system of claim 1, further comprising a seal positioned at an interface between the housing and the sleeve adjacent to the fluid inlet.

10. The electric machine cooling system of claim 1, wherein a working fluid in the stator cooling assembly is oil.

11. The electric machine cooling system of claim 1, wherein the electric machine is a multi-phase electric machine.

12. A method for operation of an electric machine cooling system, comprising:
flowing a working fluid into a fluid inlet that extends through a sleeve and a housing and is in fluidic communication with a stator cooling assembly;
wherein the electric machine includes:
the housing enclosing a stator and a rotor;
the sleeve removably coupled to the housing and circumferentially enclosing a portion of the housing; and
the fluid inlet extending through the sleeve and the housing.

13. The method of claim 12, further comprising flowing the working fluid from the fluid inlet to a first end winding chamber that is positioned on a first axial side of the electric machine;
wherein the stator cooling assembly further includes:
a second end winding chamber positioned on a second axial side of the electric machine; and
a cooling channel axially extending through a stator core.

14. The method of claim 13, further comprising flowing the working fluid from the second end winding chamber to a fluid channel that axially extends through a rotor shaft.

15. A traction motor immersion cooling system, comprising:
a sleeve enclosing a stator and a rotor;
a housing removably coupled to the sleeve and circumferentially enclosing a portion of the sleeve; and
a fluid inlet extending through at least one of the sleeve and the housing and is in fluidic communication with a first end winding chamber that surrounds a stator end winding;
wherein the first end winding chamber is included in a stator cooling assembly; and
wherein the sleeve includes a flange and the housing is coupled to the flange via an attachment device.

16. The traction motor immersion cooling system of claim 15, wherein the housing forms a pilot fit interface with the sleeve.

17. The traction motor immersion cooling system of claim 16, wherein a diameter of the pilot fit interface is substantially constant along an axial length from the flange to an axial end.

18. The traction motor immersion cooling system of claim 15, wherein the stator cooling assembly is pressurized and includes:
the first end winding chamber positioned on a first axial side of the traction motor and in direct fluidic communication with the fluid inlet;
a second end winding chamber positioned on a second axial side of the traction motor; and
a cooling channel axially extending through a stator core.

19. The traction motor immersion cooling system of claim 18, wherein the first end winding chamber includes a seal that is adjacent to an inner diameter of the stator.

20. The traction motor immersion cooling system of claim 18, further comprising a back cover that forms a portion of a boundary of a conduit that directs fluid from the second end winding chamber to a rotor shaft conduit.
